(19) United States
(12) Patent Application Publication
(10) Pub. No.: US 2026/0107297 A1
(43) Pub. Date: Apr. 16, 2026

(54) TECHNOLOGIES FOR LOGICAL CHANNEL PRIORITY ADJUSTMENT BASED ON CROSS-PACKET DEPENDENCY

(71) Applicant: Apple Inc., Cupertino, CA (US)

(72) Inventors: Ping-Heng Kuo, London (GB); Haijing Hu, Los Gatos, CA (US); Ralf Rossbach, Munich (DE)

(73) Assignee: Apple Inc., Cupertino, CA (US)

(21) Appl. No.: 19/326,527

(22) Filed: Sep. 11, 2025

Related U.S. Application Data
(60) Provisional application No. 63/706,512, filed on Oct. 11, 2024.

(51) Int. Cl. H04W 72/56; H04L 69/08; H04W 28/06

(52) U.S. Cl. CPC H04W 72/56; H04L 69/08; H04W 28/06

(57) ABSTRACT

The present application relates to devices and components including apparatus, systems, and methods for adjusting a logical channel priority and/or routing of a packet based on cross-packet dependency.

### CROSS-REFERENCE TO RELATED APPLICATION

This application claims priority to U.S. Provisional Ser. No. 63/706,512, entitled “TECHNOLOGIES FOR LOGICAL CHANNEL PRIORITY ADJUSTMENT BASED ON CROSS-PACKET DEPENDENCY,” filed on Oct. 11, 2024, which is herein incorporated by reference in its entirety for all purposes.

### TECHNICAL FIELD

This application relates generally to communication networks and, in particular, to technologies for logical channel priority adjustment based on cross-packet dependency.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates an example of protocol data unit (PDU) sets in accordance with some embodiments.

FIG. 3 illustrates an example of PDU set discarding in accordance with some embodiments.

FIG. 4 illustrates a logical channel configured with priorities in accordance with some embodiments.

FIG. 5 illustrates an example of a PDU set with packets that are submitted to a primary radio link control (RLC) entity or a secondary RLC entity, in accordance with some embodiments.

FIG. 6 illustrates an example procedure in accordance with some embodiments.

FIG. 7 illustrates an operational flow/algorithmic structure in accordance with some embodiments.

FIG. 8 illustrates another operational flow/algorithmic structure in accordance with some embodiments.

FIG. 9 illustrates a user equipment in accordance with some embodiments.

FIG. 10 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

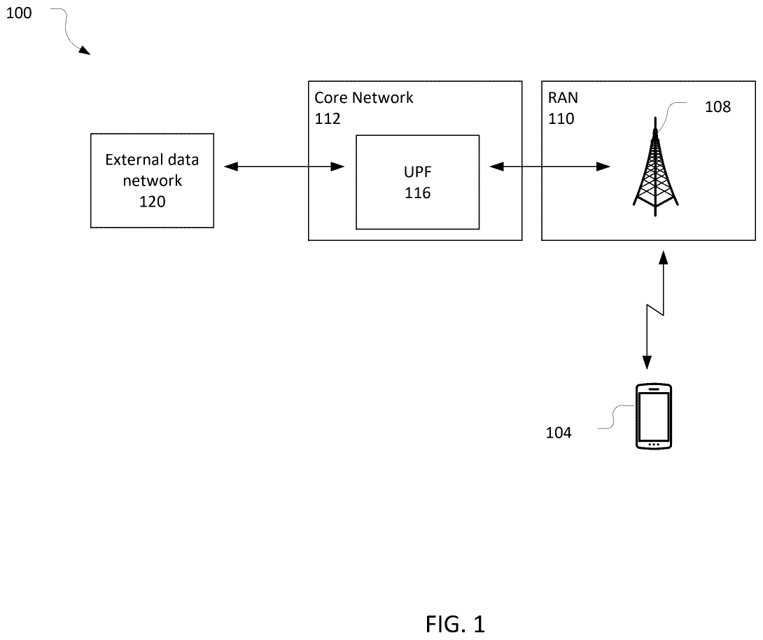

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5^{th} Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

The core network 112 may include a user plane function (UPF) 116 that provides for routing and forwarding of user plane packets between the base station 108 and an external data network 120. The base station 108 may receive uplink packets from the UE 104 through the DRBs and may transmit the uplink packets to the UPF 116 through a general packet radio service (GPRS) tunneling protocol-user plane (GTP-U) tunnel. The UPF 116 may remove the packet headers and forward the packets to the external data network 120. The UPF 116 may map downlink packets arriving from an external data network onto specific quality of service (QoS) flows belonging to specific PDU sessions before forwarding to the base station 108. The base station 108 may map the traffic to the appropriate DRBs for delivery to the UE 104.

The network environment 100 may further include an external data network 120. The external data network 120 may include a system of interconnected nodes that facilitate data transmission between UE 104 and various application servers and other service providers. The base station 108 and the core network 112 may route application data between the UE 104 and external data network 120 or application servers. These application servers host web applications, cloud storage, and multimedia streaming services, which communicate with the UE 104 via standardized protocols and interfaces defined by 3GPP, ensuring secure and efficient data exchange.

Operations described herein as performed by a device (for example, UE 104, base station 108, and/or a device of core network 112) may be fully, substantially, or partially performed by processing circuitry implemented on the device. Additionally, operations described herein as performed by “the network” may be performed by a device of the RAN 110 (e.g., base station 108), a device of the core network 112, and/or components thereof.

Embodiments herein provide techniques for logical channel (LCH) priority adjustment for packets with cross-packet dependency that are buffered in different LCHs. The embodiments may enable timely delivery of inter-related packets, thereby improving performance and/or user experience.

The UE 104 may include an application layer that generates application traffic to be transmitted to another device through the network environment 100. In some embodiments, the application layer may have an extended reality (XR, e.g., virtual reality (VR), augmented reality (AR), etc.) application that generates XR traffic. However, embodiments are not limited to XR use cases.

For XR and other services, the application layer may generate data packets, which may also be referred to as protocol data units (PDUs). The individual PDUs may be Internet protocol (IP) packets or non-IP packets. In some instances, the application layer may generate PDU sets, with individual PDU sets comprising one or more PDUs. In an example, PDU sets may be as defined in 3GPP TS 23.501 v19.1.0 (2024 Sep. 24) and/or a future 3GPP TS. The packets of a PDU set may carry a payload of one unit of information generated by the application layer. In an example, the unit of information may be a frame or video slice for XR Services such as those defined in 3GPP Technical Report (TR) 26.926 v18.2.0 (2024 Mar. 26). In some implementations all PDUs in the PDU set may be needed by an application layer at a destination node to allow the application layer to recover parts or all of the information unit. In other implementations, the application layer on the destination node may still be able to recover parts or all of the information unit even if some PDUs of a PDU set are missing.

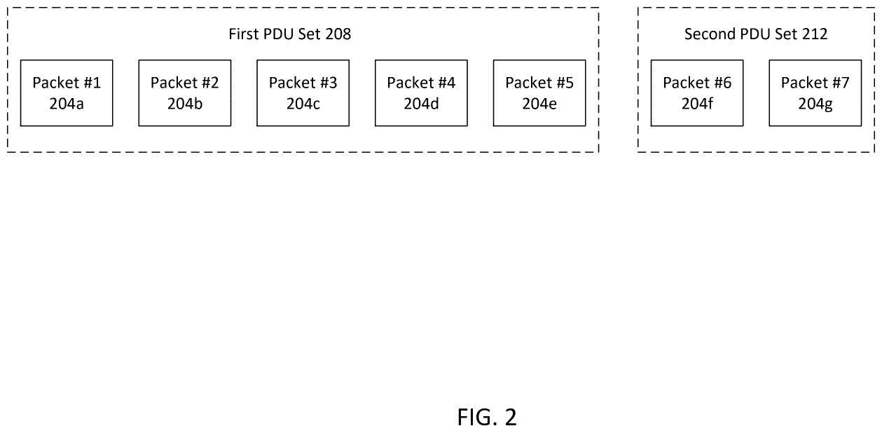

FIG. 2 illustrates an example of PDU sets in accordance with some embodiments. For example, FIG. 2 illustrates a plurality of packets 204a-204g (e.g., packets #1-#7). Packets 204a-204e (e.g., packets #1-#5) may be included in a first PDU set 208. Packets 204f and 204g (e.g., packets #6 and #7) may be included in a second PDU set 212.

In some embodiments, the data produced by an application layer of the UE 104 may include multi-modal data. Multi-modal data may include input data from different kinds of devices/sensors or the output data to different kinds of destinations (e.g. one or more UEs) desired for the same task or application. Multi-modal data may include more than one single-modal data (e.g., one type of data), and there may be a strong dependency among each single-modal data associated with multi-modal data.

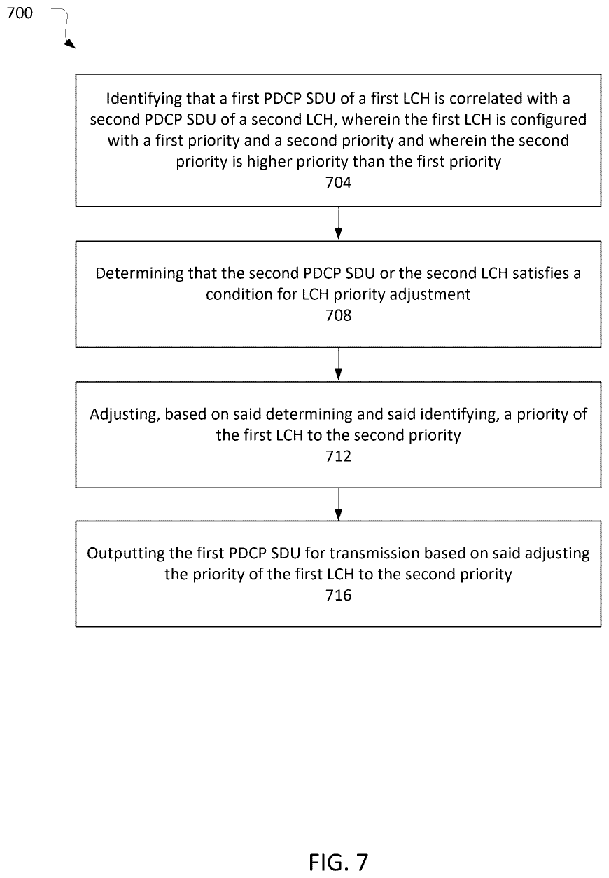

The PDUs may be provided to a transmitter of the UE 104 that is configured to execute a communication protocol stack, for example, communication protocol stack 736 of FIG. 7, to facilitate communication via the network environment 100. The transmitter may implement layer 2 (L2) and layer 1 (L1) functionality. At the L2 level, the transmitter may include a service data adaptation protocol (SDAP) layer, a packet data convergence protocol (PDCP) layer, a radio link control (RLC) layer, and a media access control (MAC) layer. At the L1 level, the transmitter may include a physical (PHY) layer. Briefly, the SDAP layer may manage QoS flow handling between the QoS flows and the DRBs. The PDCP layer may manage robust header (de)compression and security between DRBs and RLC channels. The RLC layer may manage (re-)segmentation and error correction through automatic repeat request (ARQ) between logical channels and RLC channels. The MAC layer may manage scheduling/priority handling, (de)multiplexing, and hybrid automatic repeat request (HARQ) processes between logical channels and transport channels. And the PHY layer may manage the processing of the physical data and control channels.

A packet received by a layer from higher layers may be called a service data unit (SDU) of that layer. The packet transmitted by the layer to lower layers is called the PDU of that layer. For example, packets received by a PDCP layer from an SDAP layer are called PDCP SDUs, and packets sent by the PDCP layer to an RLC layer are called PDPC PDUs. In this sense, a packet may be referred to as either an SDU or a PDU depending on the layer perspective. Thus, packets of a PDU set may be referred to as SDAP PDUs or PDCP SDUs. Further, an SDAP PDU may include the information of an application layer PDU and, therefore, the PDU set concept may apply to various protocol layers.

In some embodiments, information may be provided by the core network 112 to the RAN 110 to assist the handling of QoS flows and PDUs. This information may be consistent with that described in 3GPP TS 23.501, Section 5.7 (e.g., Section 5.7.7 related to PDU set QoS parameters) and/or 3GPP TR 23.700-60 v18.0.0 (2022 Dec. 21). This information may include semi-static information for both uplink and downlink, PDU set QoS parameters, and dynamic information for downlink.

The semi-static information for both uplink and downlink may be provided via control plane (e.g., next generation application protocol (NGAP)). This information may include periodicity for uplink and downlink traffic of the QoS Flow via time sensitive communications assistance information (TSCAI)/time sensitive communications assistance container (TSCAC); and traffic jitter information (e.g. jitter range) associated with each periodicity of the QoS flow.

The PDU set QoS parameters may include a PDU Set Error Rate (PSER) to define an upper bound for the rate of PDU Sets that have been processed by the sender of a link layer protocol but that are not successfully delivered by the corresponding receiver to the upper layer. See, for example, 3GPP TS 23.501, Section 5.7.7.3. In some instances, a PDU set may be considered as successfully delivered when all PDUs of a PDU Set are delivered successfully. In other instances, other definitions of successful delivery may be made.

The PDU set QoS parameters may further include a PDU Set Delay Budget (PSDB) that defines a time between reception of a first PDU and successful delivery of a last-arrived PDU of a PDU Set. See, for example, 3GPP TS 23.501, Section 5.7.7.2. The PSDB may be an optional parameter in various embodiments.

The PDU set QoS parameters may further include a PDU Set Integrated Handling Indication (PSIHI) to indicate whether all PDUs in the PDU sets are needed by an application layer. See, for example, 3GPP TS 23.501, Section 5.7.7.4. In instances where the application layer needs all PDUs in the PDU set, there is no need for the transmitter to continue to transmit every PDU when at least one PDU of the corresponding PDU set is already discarded. Thus, this provides an opportunity to improve resource efficiency by avoiding unnecessary transmissions.

The dynamic information may be provided by user plane (e.g., a general packet radio service (GPRS) tunneling protocol (GTP)—user plane (GTP-U) header). This information may include, for example: a PDU set sequence number (SN); a PDU set size (in bytes); a PDU SN within a PDU Set; an end PDU of the PDU Set indication; a PDU set importance (PSI); and/or an end of data burst indication in the header of a last PDU of the data burst.

The PDU set importance (PSI) may be used to identify a relative importance of a PDU set compared to other PDU sets within the same QoS flow. In some embodiments, PSI-based SDU discarding may be employed by a transmitting device. For example, the UE may be configured by the network to start different discard timers (e.g., discardTimer and discardTimerLowImportance) for packets belonging to PDU sets with different importance levels.

Each PDCP SDU may maintain its own discard timer. This may be the case even for PDCP SDUs belonging to the same PDU set. PDCP SDUs belonging to the same PDU set do not necessarily arrive at the same time. This may be due to, for example, uplink (UL) jitter in tethered use cases, where packets experience different jitter before reaching the UE. Thus, each PDCP SDU may have different remaining times, even if they belong to the same PDU set.

In some embodiments, PDU set discarding may be employed by a transmitting device. For example, the gNB may configure PDU set discarding based on the PSIHI QoS parameter. In some embodiments, PDU set discarding may be configured per PDCP entity.

The PDU set discarding may be similar to that described in 3GPP TR 38.835 v18.0.1 (2023 Apr. 5). For example, in some instances a threshold number of PDUs of a PDU set may be desired for a receiving application layer to use the unit of information. The threshold number may be one or more than one. If PDU set discarding is configured and a transmitting device determines, for example, the number of PDUs of a PDU set are lost/discarded exceeds the threshold number, the transmitting device may discard the remaining PDUs of the PDU set without transmission in order to free up radio resources. In some embodiments, a PDU may be determined to be lost/discarded if it is not successfully transmitted prior to expiration of the PDU's discard timer. A PDU may be discarded as described herein or for other reasons, e.g., the PDU depends on another PDU that was lost.

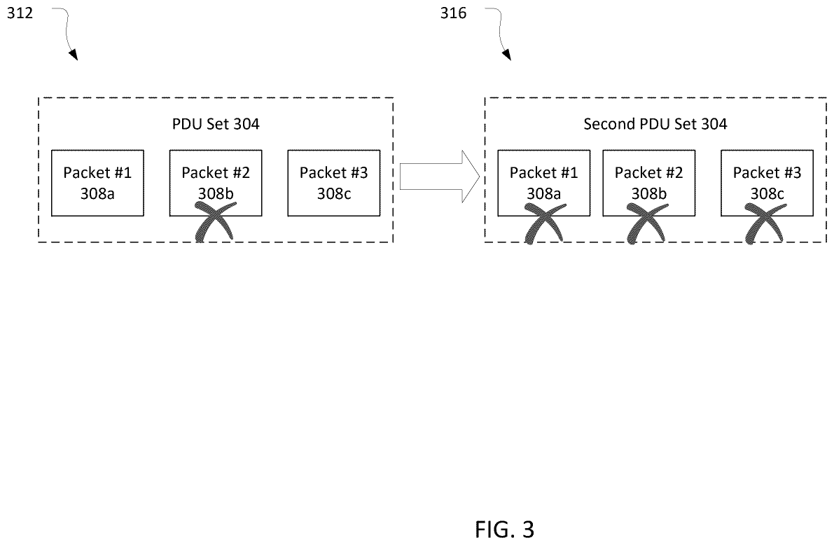

Accordingly, with PDU set discarding, the transmitting device (e.g., UE) may discard all packets in a PDU set when one (or more) of the packets in the PDU set is lost/discarded, even if the discard timers for the other packets are still running. FIG. 3 illustrates an example of PDU set discarding in accordance with some embodiments. A PDU set 304 may include packets 308a-c. As shown at 312 in FIG. 3, packet 308b of the PDU set 304 may be discarded. As shown at 316 of FIG. 3, in accordance with PDU set discarding, the UE may discard packets 308a and 308c based on packet 308b being discarded.

Accordingly, there may be a dependency among the packets in the same PDU set. Such cross-packet dependency may also exist in other cases. For example, packets belonging to different PDU set may depend on each other based on inter-PDU set correlation. In another example, packets belonging to different traffic flows may depend on each other based on multi-modality correlation.

In some instances, delay-aware scheduling may be applied to reduce packet discarding. For example, if a network knows that a remaining time until discard timer expiry for a PDU is already quite short, delivery of this PDU may be considered urgent and the network may perform a timely resource allocation to ensure the PDU is timely transmitted. This may reduce the number of packets that need to be discarded, and hence improves user experience.

Delay status reporting (DSR) may include an uplink MAC control element (CE) that enables a UE to report the explicit remaining time until expiration of discard timer (per logical channel group (LCG)) and an associated data volume. If no DSR is triggered for an LCH/LCG, a new DSR may be triggered for the LCH/LCG when a shortest remaining-time left for buffered data in uplink is smaller than a configured remaining time threshold. One or more thresholds may be configured per LCG for DSR triggering purposes. If PDU set discarding is configured, a data volume calculation to be reported in the DSR may consider a size of the full remaining PDUs in the PDU set (if any PDU within the PDU set is associated with a remaining time below the threshold). In some instances, single delay information per LCG may be supported as a baseline for DSR. The remaining time, for example, the shortest remaining time in the LCG, may be explicitly reported in the DSR. It is anticipated that, in Release 19 3GPP TSs, DSR enhancements with multiple remaining time thresholds configured for an LCH/LCG may be introduced, which enables the UE to report more comprehensive information of the buffer delay status.

While such feedback information may allow the network to perform delay-aware scheduling, it may not guarantee that urgent packets can be delivered sooner. For example, the network may choose to skip scheduling if it thinks that the remaining time is already too short. Thus, such information only assists the network to make more judicious decisions in terms of radio resource management.

Release 19 3GPP Technical Specifications (TSs) may require enhancements to delivery of XR data using delay/deadline information to support uplink (UL) scheduling. These enhancements may enable high XR capacity while meeting delay requirements and/or avoiding excessive delay of delivering PDUs.

Logical channel prioritization (LCP) is a procedure performed by the MAC layer to allocate data from one or more LCHs to a radio resource for transmission based on parameters such as priority configured for each LCH. Various LCP enhancements may be based on buffer delay. For example, delay-aware LCP enhancement may be used to resolve an issue of data with a low remaining time being delayed due to data from other LCHs with no delay critical data. As compared to DSR, such enhancements may represent a more proactive mechanism that a UE may apply to minimize UL packet discarding. For delay-aware LCP enhancement, priority of an LCH may be overridden/adjusted based on delay/deadline information. This may be enabled by use of one or more additional priorities configured to an LCH that has, or may have, delay-critical data. If priority of an LCH is adjusted, the adjusted priority may apply to all data within the LCH, or may apply only to the delay-critical data within the LCH. The delay-aware LCP mechanism may be configured in a semi-static way. No dynamic indications may be needed for triggering these delay-aware LCP mechanisms. In some instances, use of delay-aware LCP mechanisms may not prevent non-delay critical data from using an UL grant. Data that is considered delay-critical for purposes of the delay-aware LCP mechanisms may be based on a remaining time threshold used for DSR or it could be a separate remaining time threshold.

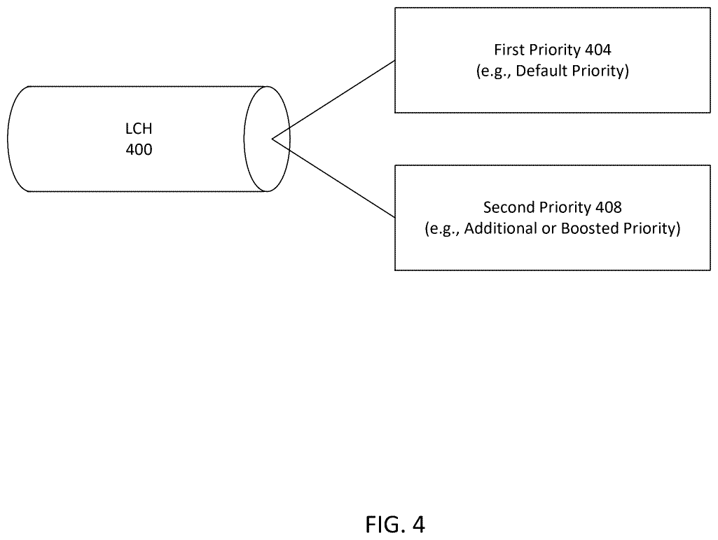

In various embodiments, a LCH may be configured with multiple LCH priorities. For example, FIG. 4 shows an LCH 400 that is configured with two LCH priorities in accordance with some embodiments. In some embodiments, a network may provide the UE with configuration information via RRC signaling, for example, to semi-statically configure the priorities for the LCH.

In some embodiments, the configured priorities may include a first priority 404 (e.g., a default LCH priority level) and a second priority 408 (e.g., an additional or boosted LCH priority level). The LCH 400 may have the first priority 404 (e.g., default priority) in a default state, e.g., when all packets in a buffer of the LCH 400 have a remaining time to discard (for example, remaining time until expiry of respective discard timers) larger than a threshold. The UE may switch the priority level of the LCH 400 to the second priority 408 (e.g., additional or boosted LCH priority level) based on a condition. The condition may include, for example, that the remaining time of at least one packet in the buffer of the LCH 400 is smaller than the threshold. Such LCH priority adaptation can happen even before an uplink (UL) grant is received. This may avoid dynamic adaptation during LCP procedure that may increase complexity. When the condition is no longer met (e.g., there are no more packets with remaining time smaller than the threshold in the buffer of the LCH 400), the UE may switch the priority back to the first priority 404.

In some embodiments, a PDCP entity may be associated with multiple RLC entities for split bearer. For example, the PDCP can have one primary RLC entity and at least one secondary RLC entity. With split bearer, each PDCP PDU can be submitted to either primary or secondary RLC when the uplink data volume exceeds a threshold (e.g., ul-DataSplitThreshold). The two RLC entities for the split bearer correspond to different logical channels in the MAC layer.

In some instances, the packets of a PDU set may have cross-packet dependency (e.g., PDU set discarding is configured), and the packets of the PDU set may be submitted to either the primary or secondary RLC entity. The packets of the PDU set may have one or more packets with remaining time less than (or equal to) the remaining time threshold and one or more packets with remaining time larger than the remaining time threshold. If LCH priority adjustment is solely based on remaining time, only the LCH that buffers the packet(s) with remaining time smaller than (or equal to) the threshold will adjust its priority. However, all packets belonging to the same PDU set (e.g., buffered on either of the LCHs) should be transmitted rapidly due to their cross-packet dependency.

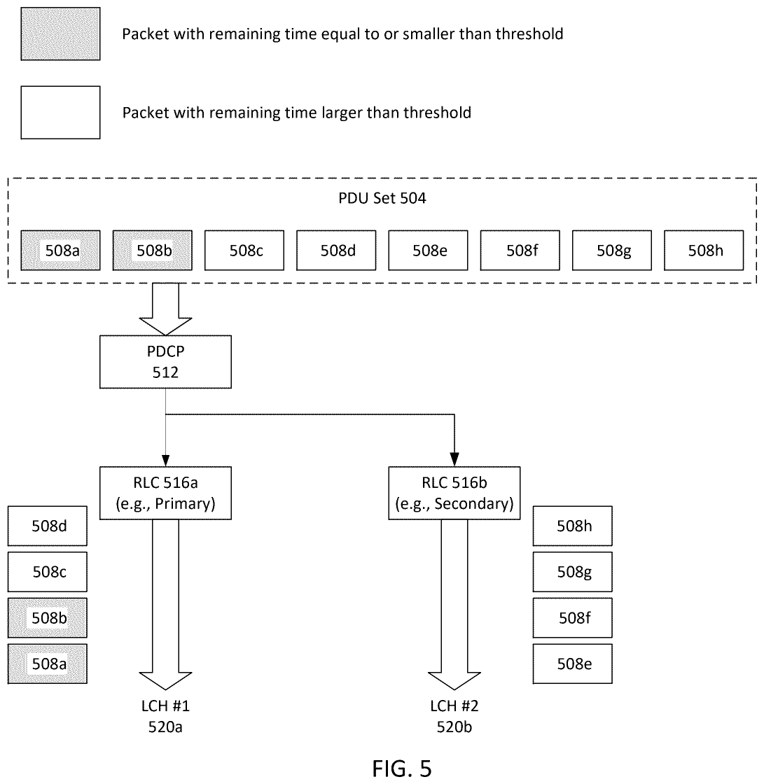

FIG. 5 illustrates an example of a PDU set 504 with packets 508a-h that are submitted to a PDCP 512. The PDCP 512 may split the packets 508a-h between a first RLC 516a (e.g., a primary RLC) and a second RLC 516b (e.g., a secondary RLC). For example, as shown in FIG. 5, As shown packets 508a-d may be submitted to the first RLC 516a and packets 508e-h may be submitted to the second RLC 516b. The first RLC 516a may be associated with a first LCH 520a, and the second RLC 516b may be associated with a second LCH 520b.

In an example, a subset of at least one of the packets 508a-h may have a remaining time equal to or less than the threshold. For example, as shown in FIG. 5, packets 508a and 508b (submitted to the first RLC 516a) have remaining time equal to or less than the threshold, while packets 508c-e have remaining time greater than the threshold. As a result, only the LCH 520a corresponding to the first RLC 516a is buffered with packets that satisfy the criteria of LCH priority adjustment (e.g., according to remaining time till discard). In legacy operation, the second LCH 520b corresponding to the secondary RLC 516b may not be adjusted even though it is also buffered with packets that belong to a PDU Set that should be transmitted urgently.

Embodiments herein provide techniques for LCH priority adjustment for packets with cross-packet dependency that are buffered in different logical channels. While embodiments are primarily described with reference to a UE, the embodiments may additionally or alternatively be implemented by another transmitting device, such as a base station (e.g., base station 108), a device of the core network (e.g., core network 112), a device of the external data network (e.g., external data network 120), or components thereof.

For example, a first LCH may be configured with LCH priority adjustment (e.g., configured with a first priority (such as a default priority) and a second priority (such as an additional or boosted priority)). The second priority may be higher priority than the first priority. The priority level of the first LCH may be adjusted from the first priority to the second priority based on at least one triggering condition.

In an example, the triggering condition may include that the first LCH is already using the additional priority (e.g., the priority has already been adjusted). In another example, the triggering condition may include that any (e.g., at least one) PDCP SDU in the buffer of the first LCH has a remaining time till expiry of its discard timer less than (e.g., or equal to) a remaining time threshold.

In some embodiments, at least one first PDCP SDU in the buffer of the first LCH may be correlated to at least one second PDCP SDU in the buffer of a second LCH, and the triggering condition may be based on the at least one second PDCP SDU and/or the second LCH. For example, the triggering condition may include that the at least one second PDCP SDU in the buffer of the second LCH satisfies the condition of LCH priority adjustment (e.g., the second PDCP SDU has a remaining time smaller than the remaining time threshold). Consider an example with reference to FIG. 5, in which packets 508a and 508b, buffered in LCH 520a, satisfy the condition of LCH priority adjustment by having a remaining time till discard less than the threshold. The priority of LCH 520a may be increased to the second priority based on the packets 508a and/or 508b. Likewise, if at least one of the packets 508e-h, buffered in LCH 520b, is correlated with packet 508a and/or packet 508b, the priority of LCH 520b may be increased to the second priority based on the correlation.

In another example, the triggering condition may include that the priority of the second LCH has been adjusted to the second priority (e.g., additional or boosted priority). For example, the priority of the second LCH may have been boosted based on the correlated PDCP SDU and/or another PDCP SDU satisfying the condition of LCH priority adjustment (e.g., having a remaining time till discard of less than the remaining time threshold). Consider another example with reference to FIG. 5. The priority of LCH 520a may be increased to the second priority based on the packets 508a and/or 508b meeting the condition for LCH priority adjustment. The priority of LCH 520b may be increased to the second priority based on an association between the LCH 520b with the LCH 520a.

Accordingly, the triggering condition may be based on the correlated PDCP SDU and/or based on the second LCH (e.g., regardless of the correlated PDCP SDU). Having the triggering condition based on the second LCH may be simpler to implement but less optimal than having the triggering condition based on the correlated PDCP SDU.

In some embodiments, the triggering condition with respect to the correlated PDCP SDU buffered in the second LCH and/or based on the second LCH itself may be applied based on the DRB being configured with PDU set discarding. For example, the triggering condition may not be used when PDU set discarding is not configured.

When the priority of the first LCH is boosted to the second priority, the priority may fallback to the first priority (e.g., default priority) based on at least one fallback condition. For example, the fallback condition may include that the at least one second PDCP SDU in the buffer of the second LCH (e.g., which is correlated with the at least one first PDCP SDU in the buffer of the first LCH) has been discarded. In another example, the fallback condition may include that the second LCH has fallen back to its default priority. In another example, the fallback condition may include that the at least one first PDCP SDU in the buffer of the first LCH (e.g., which triggered the priority adjustment to the second priority) has been transmitted or discarded. In another example, the fallback condition may include that none of the other PDCP SDUs in the buffer of the first LCH satisfy the condition for LCH priority adjustment.

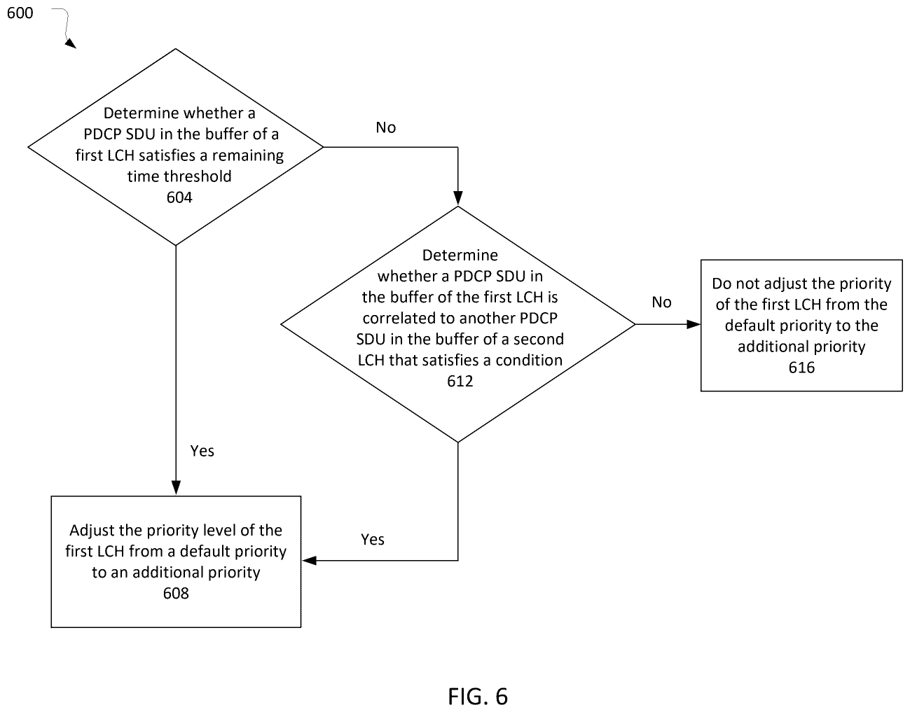

FIG. 6 illustrates an example procedure 600 in accordance with some embodiments. The procedure 600 may be performed by a transmitting entity (e.g., a UE, such as UE 104, and/or a network device, such as base station 108, a device of core network 112, and/or a device of external data network 120), or components thereof. The procedure 600 may be performed for a first LCH that is configured with LCH priority adjustment (e.g., configured with a first priority (such as a default priority) and a second priority (such as a boosted or additional priority)).

At 604, the procedure 600 may include to determine if any (e.g., at least one) PDCP SDU in the buffer of a first LCH satisfies a remaining time threshold. If yes, then at 608, the procedure 600 may include to switch the priority of the first LCH from the default priority to the additional priority (e.g., the boosted priority). If no, then at 612, the procedure 600 may include to determine if any PDCP SDU in the buffer is correlated to another PDCP SDU in the buffer of a second LCH that satisfies a condition. The condition may be, for example, that the other PDCP SDU satisfies the remaining time threshold (e.g., has a remaining time until discard less than a remaining time threshold) and/or that the second LCH has been adjusted to the additional priority of the second LCH. If the determination at 612 is yes, then the procedure 600 may include to switch the priority of the LCH from the default priority to the additional priority (e.g., at 608 of the procedure 600). If the determination at 612 is no, then the procedure 600 may include, at 616, to not switch the priority of the LCH from the default priority to the additional priority.

An example update to 3GPP TS 38.321 (e.g., for Rel-19) is as follows (additions in underline):
If an LCH is configured with an additional priority, the MAC entity shall for each logical channel:
1> if at least one remaining value of the running PDCP discardTimers among all the PDCP SDUs buffered for the logical channel that have not been transmitted in any MAC PDU becomes below logicalChannelRemainingTimeThreshold; and
1> if any PDCP SDU buffered for the logical channel belongs to the same PDU Set as another PDCP SDU buffered for another logical channel whose remaining value of the PDCP discardTimer becomes below logicalChannelRemainingTimeThreshold ; and
1> if the priority of the logical channel is not set as the additional priority:
   2> set the priority for the logical channel as the additional priority.

In some embodiments, a PDCP re-routing rule based on packet dependency (e.g., correlation) may be employed. For example, the rule may mandate how packet re-routing is performed by the PDCP entity for split bearer when the data volume exceeds an uplink data split threshold (e.g., ul-DataSplitThreshold). In some embodiments, the rule may dictate that correlated packets are submitted to the same RLC entity (e.g., and hence they will be buffered for the same logical channel).

For example, in accordance with the rule, if PDU set discarding is configured for a DRB, all packets belonging to the same PDU set may be submitted to either the primary RLC entity or the secondary RLC entity, even when the data volume exceeds the uplink data split threshold (e.g., ul-DataSplitThreshold).

In some embodiments, when the PDCP re-routing rule is applied, the techniques for adjusting LCH priority based on correlated SDUs in other LCHs may not be needed.

FIG. 7 illustrates an operational flow/algorithmic structure 700 in accordance with some embodiments. The operational flow/algorithmic structure 700 may be implemented by a transmitting entity (e.g., a UE, such as UE 104, and/or a network device, such as base station 108, a device of core network 112, and/or a device of external data network 120), or components thereof (e.g., baseband circuitry 904 and/or 1004).

The operational flow/algorithmic structure 700 may include, at 704, identifying that a first PDCP SDU of a first LCH is correlated with a second PDCP SDU of a second LCH, wherein the first LCH is configured with a first priority and a second priority and wherein the second priority is higher priority than the first priority. In an example, the first and second PDCP SDUs may be correlated based on being included in a same PDU set, based on inter-PDU set correlation, and/or based on multi-modality correlation.

The operational flow/algorithmic structure 700 may further include, at 708, determining that the second PDCP SDU or the second LCH satisfies a condition for LCH priority adjustment. In an example, the condition includes that the second PDCP SDU has a time remaining until discard that is less than a time remaining threshold. In some embodiments, a UE may receive configuration information from the network to indicate the time remaining threshold. In another example, the condition includes that the priority of the second LCH has been adjusted to a boosted priority.

The operational flow/algorithmic structure 700 may further include, at 712, adjusting, based on said determining and said identifying, a priority of the first LCH to the second priority.

The operational flow/algorithmic structure 700 may further include, at 716, outputting the first PDCP SDU for transmission based on said adjusting the priority of the first LCH to the second priority. For example, the transmitting device may allocate the first PDCP SDU from the first LCH to a radio resource for transmission based on the second priority.

In an example, the transmitting device may adjust the priority of the first LCH from the second priority to the first priority based on a determination that second PDCP SDU has been discarded. In another example, the transmitting device may adjust the priority of the first LCH from the second priority to the first priority based on a determination that the first PDCP SDU has been transmitted or discarded.

In an example, the first LCH may be associated with a primary RLC entity of a PDCP entity and the second LCH may be associated with a secondary RLC entity of the PDCP entity. In another example, the first LCH may be associated with the secondary RLC entity and the second LCH may be associated with the primary RLC entity.

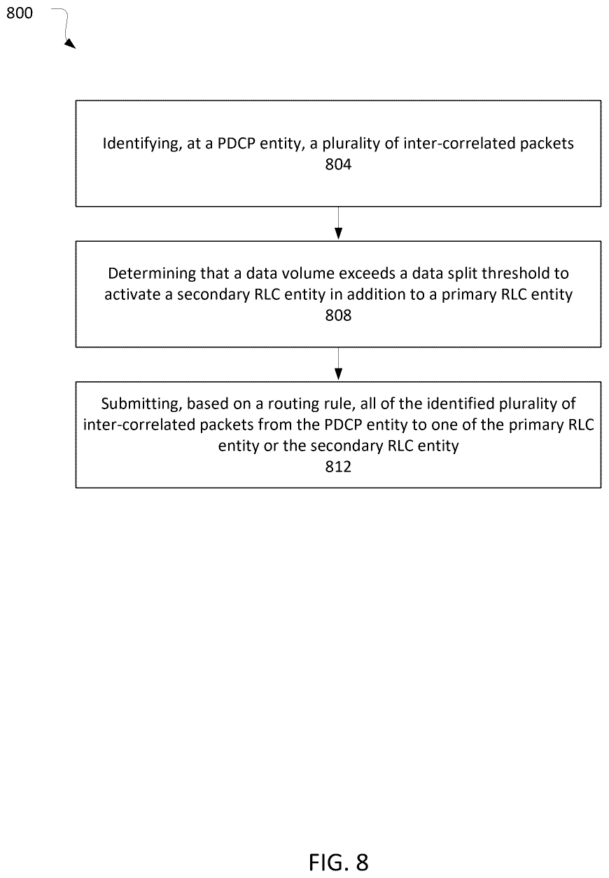

FIG. 8 illustrates another operational flow/algorithmic structure 800 in accordance with some embodiments. The operational flow/algorithmic structure 800 may be implemented by a transmitting entity (e.g., a UE, such as UE 104, and/or a network device, such as base station 108, a device of core network 112, and/or a device of external data network 120), or components thereof (e.g., baseband circuitry 904 and/or 1004).

The operational flow/algorithmic structure 800 may include, at 804, identifying, at a PDCP entity, a plurality of inter-correlated packets. In an example, the plurality of inter-correlated packets may belong to a same PDU set, a plurality of inter-dependent PDU Sets, or a plurality of inter-dependent multi-modality traffic flows.

The operational flow/algorithmic structure 800 may further include, at 808, determining that a data volume exceeds a data split threshold to activate a secondary RLC entity in addition to a primary RLC entity.

The operational flow/algorithmic structure 800 may further include, at 812, submitting, based on a routing rule, all of the identified plurality of inter-correlated packets from the PDCP entity to one of the primary RLC entity or the secondary RLC entity. In an example, the transmitting entity may further store all of the identified plurality of inter-correlated packets in a transmission buffer of a logical channel associated with the primary RLC entity or the secondary RLC entity for transmission. In a further example, the transmitting entity may determine that a first packet, of the identified plurality of inter-correlated packets, has a remaining time until discard that is less than a remaining time threshold. The transmitting entity may increase, based on the determination that the first packet has a remaining time until discard that is less than the remaining time threshold, a priority of the logical channel from a first priority to a second priority.

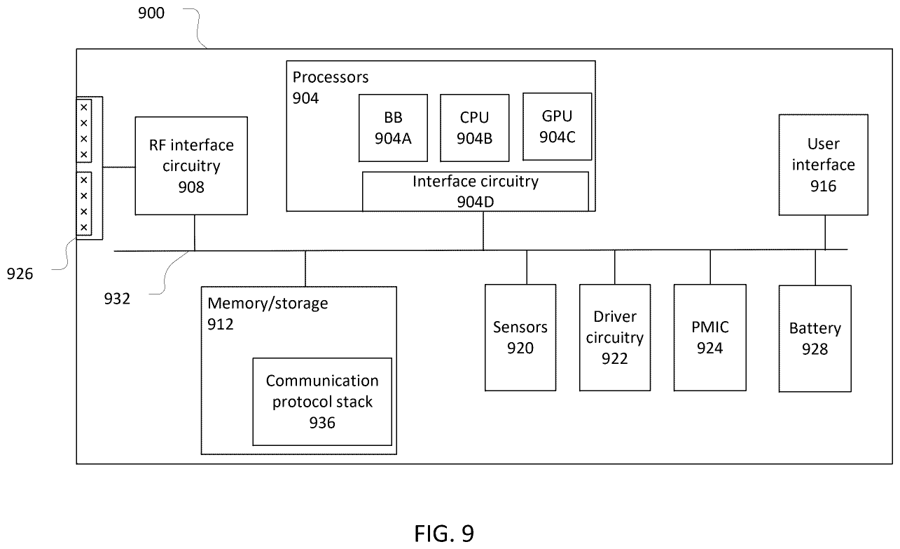

FIG. 9 illustrates a UE 900 in accordance with some embodiments. The UE 900 may be similar to and substantially interchangeable with UE 104.

The UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 900 may include processors 904, RF interface circuitry 908, memory/storage 912, user interface 916, sensors 920, driver circuitry 922, power management integrated circuit (PMIC) 924, antenna 926, and battery 928. The components of the UE 900 may be implemented as integrated circuits (ICs), portions thereof, discrete electronic devices, or other modules, logic, hardware, software, firmware, or a combination thereof. In some embodiments, at least one processor 904 may include RF interface circuitry 908. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 932, which may represent any type of interface, input/output, bus (local, system, or expansion), transmission line, trace, or optical connection that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform LCH priority transitions as described herein. The processors 904 may also include interface circuitry 904D to enable communication by, for example, communicatively coupling the processor circuitry with one or more other components of the UE 900.

In some embodiments, the baseband processor 904A may access a communication protocol stack 936 in the memory/storage 912 to communicate over a 3GPP compatible network. In general, the baseband processor 904A may access the communication protocol stack 936 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 908.

The baseband processor 904A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 912 may include one or more non-transitory, computer-readable media that includes instructions (for example, communication protocol stack 936) that may be executed by one or more of the processors 904 to cause the UE 900 to perform LCH priority transitions as described herein.

The memory/storage 912 includes any type of volatile or non-volatile memory that may be distributed throughout the UE 900. In some embodiments, some of the memory/storage 912 may be located on the processors 904 themselves (for example, memory/storage 912 may be part of a chipset that corresponds to the baseband processor 904A), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 908 may include transceiver circuitry and a radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 926 and proceed to filter and amplify (with a low-noise amplifier) the signal. The signal may be provided to a receiver of the transceiver that down-converts the RF signal into a baseband signal that is provided to the baseband processor of the processors 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various embodiments, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, or phased array antennas. The antenna 926 may have one or more panels designed for specific frequency bands including bands in FR1 or FR2.

The user interface 916 includes various input/output (I/O) devices designed to enable user interaction with the UE 900. The user interface 916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 900.

The sensors 920 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various input/output (I/O) devices that may be present within, or connected to, the UE 900. For example, driver circuitry 922 may include a display driver to control and allow access to a display device, a touchscreen driver to control and allow access to a touchscreen interface, sensor drivers to obtain sensor readings of sensors 920 and control and allow access to sensors 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage power provided to various components of the UE 900. In particular, with respect to the processors 904, the PMIC 924 may control power-source selection, voltage scaling, battery charging, or DC-to-DC conversion.

A battery 928 may power the UE 900, although in some examples the UE 900 may be mounted deployed in a fixed location and may have a power supply coupled to an electrical grid. The battery 928 may be a lithium ion battery, a metal-air battery, such as a zinc-air battery, an aluminum-air battery, a lithium-air battery, and the like. In some implementations, such as in vehicle-based applications, the battery 928 may be a typical lead-acid automotive battery.

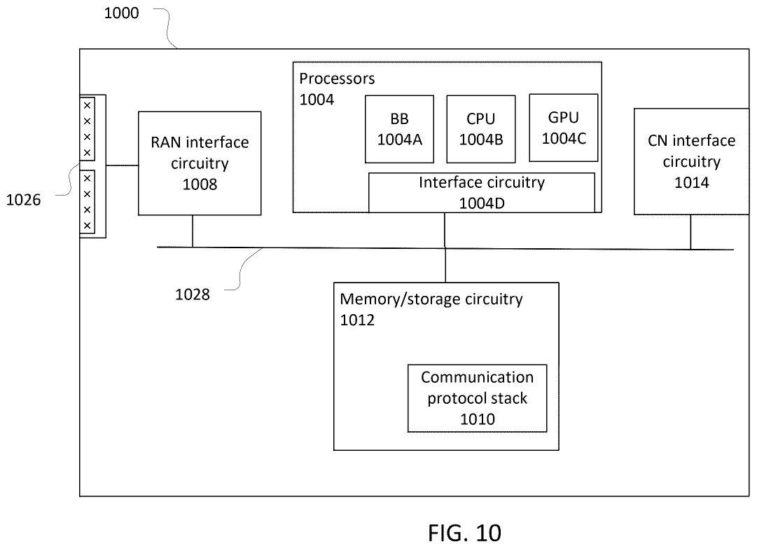

FIG. 10 illustrates a network device 1000 in accordance with some embodiments. The network device 1000 may be similar to, and substantially interchangeable with, the base station 108.

The network device 1000 may include processors 1004, RF interface circuitry 1008 (if implemented as a base station), core network (CN) interface circuitry 1014, memory/storage circuitry 1012, and antenna structure 1026.

The components of the network device 1000 may be coupled with various other components over one or more interconnects 1028.

The processors 1004, RF interface circuitry 1008, memory/storage circuitry 1012 (including communication protocol stack 1010), antenna structure 1026, and interconnects 1028 may be similar to like-named elements shown and described with respect to FIG. 9.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage circuitry 1012 to cause the network device 1000 to configure a UE as described herein. The processors 1004 may also include interface circuitry 1004D to communicatively couple the processor circuitry with one or more other components of the network device 1000.

The CN interface circuitry 1014 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 1000 via a fiber optic or wireless backhaul. The CN interface circuitry 1014 may include one or more dedicated processors or FPGAs to communicate using one or more of the aforementioned protocols. In some implementations, the CN interface circuitry 1014 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method comprising: identifying that a first protocol data convergence protocol (PDCP) service data unit (SDU) of a first logical channel (LCH) is correlated with a second PDCP SDU of a second LCH, wherein the first LCH is configured with a first priority and a second priority and wherein the second priority is higher priority than the first priority; determining that the second PDCP SDU satisfies a condition for LCH priority adjustment; adjusting, based on said determining and said identifying, a priority of the first LCH to the second priority; and outputting the first PDCP SDU for transmission based on said adjusting the priority of the first LCH to the second priority.

Example 2 includes the method of example 1 or some other example herein, wherein the second PDCP SDU is correlated with the first PDCP SDU based on being included in a same protocol data unit (PDU) set.

Example 3 includes the method of example 1 or some other example herein, wherein the second PDCP SDU is correlated with the first PDCP SDU based on inter-protocol data unit (PDU) set correlation or multi-modality correlation.

Example 4 includes the method of example 1 or some other example herein, wherein the condition includes that the second PDCP SDU has a time remaining until discard that is less than a time remaining threshold.

Example 5 includes the method of example 4 or some other example herein, further comprising receiving, from a network, configuration information to indicate the time remaining threshold.

Example 6 includes the method of example 1 or some other example herein, further comprising adjusting the priority of the first LCH from the second priority to the first priority based on a determination that second PDCP SDU has been discarded.

Example 7 includes the method of example 1 or some other example herein, further comprising adjusting the priority of the first LCH from the second priority to the first priority based on a determination that the first PDCP SDU has been transmitted or discarded.

Example 8 includes the method of example 1 or some other example herein, further comprising allocating the first PDCP SDU from the first LCH to a radio resource for transmission based on the second priority.

Example 9 includes the method of example 1 or some other example herein, wherein the first LCH is associated with a primary radio link control (RLC) entity of a PDCP entity and the second LCH is associated with a secondary RLC entity of the PDCP entity.

Example 10 includes an apparatus comprising processor circuitry to: store a first protocol data convergence protocol (PDCP) service data unit (SDU) in a first buffer of a first logical channel (LCH) for transmission, wherein the first LCH is configured with a first default priority and a first additional priority; identify a correlation between the first PDCP SDU and a second PDCP SDU, wherein the second PDCP SDU is stored in a second buffer of a second LCH; determine that the second PDCP SDU satisfies a condition for LCH priority adjustment or that a priority of the second LCH has already been adjusted to a second additional priority configured for the second LCH; adjust, based on the determination and the correlation, a priority of the first LCH to the first additional priority; and output the first PDCP SDU for transmission based on the first additional priority. In some embodiments, the apparatus may further include interface circuitry coupled to the processor circuitry to enable communication.

Example 11 includes the apparatus of example 10 or some other example herein, wherein the correlation includes that the first and second PDCP SDUs are included in a same protocol data unit (PDU) set.

Example 12 includes the apparatus of example 10 or some other example herein, wherein the correlation includes an inter-protocol data unit (PDU) set correlation or a multi-modality correlation.

Example 13 includes the apparatus of example 10 or some other example herein, wherein the determination includes to determine that the second PDCP SDU satisfies the condition for LCH priority adjustment, wherein the condition includes that the second PDCP SDU has a time remaining until discard that is less than a time remaining threshold.

Example 14 includes the apparatus of example 10 or some other example herein, wherein the determination includes to determine that the priority of the second LCH has already been adjusted to the second additional priority.

Example 15 includes the apparatus of example 10 or some other example herein, wherein the processor circuitry is further to adjust the priority of the first LCH from the first additional priority to the first default priority based on: a determination that second PDCP SDU has been discarded; a determination that the priority of the second LCH has been adjusted from the second additional priority to the second default priority; or a determination that the first PDCP SDU has been transmitted or discarded.

Example 16 includes the apparatus of example 10 or some other example herein, wherein the first LCH is associated with a primary radio link control (RLC) entity of a PDCP entity and the second LCH is associated with a secondary RLC entity of the PDCP entity.

Example 17 includes one or more computer-readable media having instructions that, when executed, cause processor circuitry to: identify, at a protocol data convergence protocol (PDCP) entity, a plurality of inter-correlated packets; determine that a data volume exceeds a data split threshold to activate a secondary radio link control (RLC) entity in addition to a primary RLC entity; and submit, based on a routing rule, all of the identified plurality of inter-correlated packets from the PDCP entity to one of the primary RLC entity or the secondary RLC entity.

Example 18 includes the one or more computer-readable media of example 17 or some other example herein, wherein the plurality of inter-correlated packets belong to a same protocol data unit (PDU) set, a plurality of inter-dependent PDU Sets, or a plurality of inter-dependent multi-modality traffic flows.

Example 19 includes the one or more computer-readable media of example 17 or some other example herein, wherein the instructions, when executed, further cause the processor circuitry to: store all of the identified plurality of inter-correlated packets in a transmission buffer of a logical channel associated with the primary RLC entity or the secondary RLC entity for transmission.

Example 20 includes the one or more computer-readable media of example 19 or some other example herein, wherein the instructions, when executed, further cause the processor circuitry to: determine that a first packet, of the identified plurality of inter-correlated packets, has a remaining time until discard that is less than a remaining time threshold; and increase, based on the determination that the first packet has a remaining time until discard that is less than the remaining time threshold, a priority of the logical channel from a first priority to a second priority.

Example 21 includes a method comprising: storing a first protocol data convergence protocol (PDCP) service data unit (SDU) in a first buffer of a first logical channel (LCH) for transmission, wherein the first LCH is configured with a first default priority and a first additional priority; identifying a second PDCP SDU that is correlated with the first PDCP SDU, wherein the second PDCP SDU is stored in a second buffer of a second LCH; determining that the second PDCP SDU satisfies a condition for LCH priority adjustment or that a priority of the second LCH has already been adjusted to a second additional priority configured for the second LCH; and adjusting, based on the determining, a priority of the first LCH to the first additional priority.

Example 22 includes the method of example 21 or some other example herein, wherein the second PDCP SDU is correlated with the first PDCP SDU based on being included in a same protocol data unit (PDU) set.

Example 23 includes the method of example 21 or some other example herein, wherein the second PDCP SDU is correlated with the first PDCP SDU based on inter-PDU set correlation or multi-modality correlation.

Example 24 includes the method of example 21 or some other example herein, wherein the determining includes determining that the second PDCP SDU satisfies the condition for LCH priority adjustment, wherein the condition includes that the second PDCP SDU has a time remaining until discard that is less than a time remaining threshold.

Example 25 includes the method of example 21 or some other example herein, wherein the determining includes determining that a priority of the second LCH has already been adjusted to the second additional priority.

Example 26 includes the method of example 21 or some other example herein, further comprising adjusting the priority of the first LCH from the first additional priority to the first default priority based on: a determination that second PDCP SDU has been discarded; a determination that the priority of the second LCH has been adjusted from the second additional priority to the second default priority; or a determination that the first PDCP SDU has been transmitted or discarded.

Example 27 includes the method of example 21 or some other example herein, further comprising allocating the first PDCP SDU from the first LCH to a radio resource for transmission based on the first additional priority.

Example 28 includes the method of example 21 or some other example herein, wherein the first LCH is associated with a primary radio link control (RLC) entity of a PDCP entity and the second LCH is associated with a secondary RLC entity of the PDCP entity.

Example 29 includes a method comprising: identifying, at a protocol data convergence protocol (PDCP) entity, a plurality of inter-correlated packets; determining that a data volume exceeds a data split threshold to activate a secondary radio link control (RLC) entity in addition to a primary RLC entity; and submitting all of the identified plurality of inter-correlated packets to one of the primary RLC entity or the secondary RLC entity.

Example 30 includes the method of example 29 or some other example herein, wherein the plurality of inter-correlated packets belong to a same PDU Set, a plurality of inter-dependent PDU Sets, or a plurality of inter-dependent multi-modality traffic flows.

Example 31 includes the method of example 29 or some other example herein, further comprising: storing all of the identified plurality of inter-correlated packets in a transmission buffer of a logical channel associated with the primary RLC entity or the secondary RLC entity for transmission.

Example 32 includes the method of example 31 or some other example herein, further comprising: determining that a first packet, of the identified plurality of inter-correlated packets, has a remaining time until discard that is less than a remaining time threshold; and adjusting, based on the determining that the first packet has a remaining time until discard that is less than the remaining time threshold, a priority of the logical channel from a default priority to an additional priority.

Another example may include an apparatus comprising means to perform one or more elements of a method described in or related to any of examples 1-32, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-32, or any other method or process described herein.

Another example may include an apparatus comprising logic, modules, or circuitry to perform one or more elements of a method described in or related to any of examples 1-32, or any other method or process described herein.

Another example may include a method, technique, or process as described in or related to any of examples 1-32, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-32, or portions thereof.

Another example may include a signal as described in or related to any of examples 1-32, or portions or parts thereof.

Another example may include a datagram, information element, packet, frame, segment, PDU, or message as described in or related to any of examples 1-32, or portions or parts thereof, or otherwise described in the present disclosure.

Another example may include a signal encoded with data as described in or related to any of examples 1-32, or portions or parts thereof, or otherwise described in the present disclosure.

Another example may include a signal encoded with a datagram, IE, packet, frame, segment, PDU, or message as described in or related to any of examples 1-32, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-32, or portions thereof.

Another example may include a computer program comprising instructions, wherein execution of the program by a processing element is to cause the processing element to carry out the method, techniques, or process as described in or related to any of examples 1-32, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
identifying that a first protocol data convergence protocol (PDCP) service data unit (SDU) of a first logical channel (LCH) is correlated with a second PDCP SDU of a second LCH, wherein the first LCH is configured with a first priority and a second priority and wherein the second priority is higher priority than the first priority;
determining that the second PDCP SDU satisfies a condition for LCH priority adjustment;
adjusting, based on said determining and said identifying, a priority of the first LCH to the second priority; and
outputting the first PDCP SDU for transmission based on said adjusting the priority of the first LCH to the second priority.

2. The method of claim 1, wherein the second PDCP SDU is correlated with the first PDCP SDU based on being included in a same protocol data unit (PDU) set.

3. The method of claim 1, wherein the second PDCP SDU is correlated with the first PDCP SDU based on inter-protocol data unit (PDU) set correlation or multi-modality correlation.

4. The method of claim 1, wherein the condition includes that the second PDCP SDU has a time remaining until discard that is less than a time remaining threshold.

5. The method of claim 4, further comprising receiving, from a network, configuration information to indicate the time remaining threshold.

6. The method of claim 1, further comprising adjusting the priority of the first LCH from the second priority to the first priority based on a determination that second PDCP SDU has been discarded.

7. The method of claim 1, further comprising adjusting the priority of the first LCH from the second priority to the first priority based on a determination that the first PDCP SDU has been transmitted or discarded.

8. The method of claim 1, further comprising allocating the first PDCP SDU from the first LCH to a radio resource for transmission based on the second priority.

9. The method of claim 1, wherein the first LCH is associated with a primary radio link control (RLC) entity of a PDCP entity and the second LCH is associated with a secondary RLC entity of the PDCP entity.

10. An apparatus comprising:
processor circuitry to:
store a first protocol data convergence protocol (PDCP) service data unit (SDU) in a first buffer of a first logical channel (LCH) for transmission, wherein the first LCH is configured with a first default priority and a first additional priority;
identify a correlation between the first PDCP SDU and a second PDCP SDU, wherein the second PDCP SDU is stored in a second buffer of a second LCH;
determine that the second PDCP SDU satisfies a condition for LCH priority adjustment or that a priority of the second LCH has already been adjusted to a second additional priority configured for the second LCH;
adjust, based on the determination and the correlation, a priority of the first LCH to the first additional priority; and
output the first PDCP SDU for transmission based on the first additional priority; and
interface circuitry coupled to the processor circuitry to enable communication.

11. The apparatus of claim 10, wherein the correlation includes that the first and second PDCP SDUs are included in a same protocol data unit (PDU) set.

12. The apparatus of claim 10, wherein the correlation includes an inter-protocol data unit (PDU) set correlation or a multi-modality correlation.

13. The apparatus of claim 10, wherein the determination includes to determine that the second PDCP SDU satisfies the condition for LCH priority adjustment, wherein the condition includes that the second PDCP SDU has a time remaining until discard that is less than a time remaining threshold.

14. The apparatus of claim 10, wherein the determination includes to determine that the priority of the second LCH has already been adjusted to the second additional priority.

15. The apparatus of claim 10, wherein the processor circuitry is further to adjust the priority of the first LCH from the first additional priority to the first default priority based on:
a determination that second PDCP SDU has been discarded;
a determination that the priority of the second LCH has been adjusted from the second additional priority to the second default priority; or
a determination that the first PDCP SDU has been transmitted or discarded.

16. The apparatus of claim 10, wherein the first LCH is associated with a primary radio link control (RLC) entity of a PDCP entity and the second LCH is associated with a secondary RLC entity of the PDCP entity.

17. One or more non-transitory, computer-readable media having instructions that, when executed, cause processor circuitry to:
identify, at a protocol data convergence protocol (PDCP) entity, a plurality of inter-correlated packets;
determine that a data volume exceeds a data split threshold to activate a secondary radio link control (RLC) entity in addition to a primary RLC entity; and
submit, based on a routing rule, all of the identified plurality of inter-correlated packets from the PDCP entity to one of the primary RLC entity or the secondary RLC entity.

18. The one or more non-transitory, computer-readable media of claim 17, wherein the plurality of inter-correlated packets belong to a same protocol data unit (PDU) set, a plurality of inter-dependent PDU Sets, or a plurality of inter-dependent multi-modality traffic flows.

19. The one or more non-transitory, computer-readable media of claim 17, wherein the instructions, when executed, further cause the processor circuitry to:
store all of the identified plurality of inter-correlated packets in a transmission buffer of a logical channel associated with the primary RLC entity or the secondary RLC entity for transmission.

20. The one or more non-transitory, computer-readable media of claim 19, wherein the instructions, when executed, further cause the processor circuitry to:
determine that a first packet, of the identified plurality of inter-correlated packets, has a remaining time until discard that is less than a remaining time threshold; and
increase, based on the determination that the first packet has a remaining time until discard that is less than the remaining time threshold, a priority of the logical channel from a first priority to a second priority.
